(19) United States
(12) Patent Application Publication
(10) Pub. No.: US 2025/0227811 A1
(43) Pub. Date: Jul. 10, 2025

(54) COMMUNICATION METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/092,838

(22) Filed: Mar. 27, 2025

Related U.S. Application Data
(63) Continuation of application No. PCT/JP2023/035056, filed on Sep. 27, 2023.

(30) Foreign Application Priority Data
Sep. 28, 2022 (JP) 2022-155399

(51) Int. Cl. H04W 76/40; H04W 76/27; H04W 76/34

(52) U.S. Cl. CPC H04W 76/40; H04W 76/27; H04W 76/34

(57) ABSTRACT

A communication method includes the steps of: receiving, by a user equipment in a radio resource control (RRC) connected state, a first multicast configuration from a network node in a dedicated RRC message, the first multicast configuration including a reference identifier, a fixed parameter value, and a variable parameter value; receiving, by the user equipment having transitioned from the RRC connected state to an RRC inactive state, a second multicast configuration from the network node on a multicast control channel (MCCH), the second multicast configuration including the reference identifier and a new variable parameter value; and updating, by the user equipment in the RRC inactive state, the variable parameter value received in the dedicated RRC message to the new variable parameter value received on the MCCH, based on the reference identifier.

### RELATED APPLICATIONS

The present application is a continuation based on PCT Application No. PCT/JP2023/035056, filed on Sep. 27, 2023, which claims the benefit of Japanese Patent Application No. 2022-155399 filed on Sep. 28, 2022. The content of which is incorporated by reference herein in their entirety.

### TECHNICAL FIELD

The present disclosure relates to a communication method used in a mobile communication system.

### BACKGROUND

The 3rd Generation Partnership Project (3GPP, a registered trademark; the same applies below) has defined the technical specifications of New Radio (NR) that is a radio access technology of the fifth generation (5G). NR has features such as high speed, large capacity, high reliability, and low latency as compared to Long Term Evolution (LTE) that is a radio access technology of the fourth generation (4G). The 3GPP has defined technical specifications of multicast/broadcast services (MBS) of 5G/NR (for example, see Non-Patent Document 1).

### CITATION LIST

### Non-Patent Literature

Non-Patent Document 1: 3GPP Technical Specification: TS 38.300 V17.1.0

### SUMMARY

In a first aspect, a communication method is used in a mobile communication system that provides a multicast/broadcast service (MBS), the communication method including the steps of: receiving, by a user equipment in a radio resource control (RRC) connected state, a first multicast configuration from a network node (or network apparatus) in a dedicated RRC message, the first multicast configuration including a reference identifier, a fixed parameter value, and a variable parameter value; receiving, by the user equipment having transitioned from the RRC connected state to an RRC inactive state, a second multicast configuration from the network node on a multicast control channel (MCCH), the second multicast configuration including the reference identifier and a new variable parameter value; and updating, by the user equipment in the RRC inactive state, the variable parameter value received in the dedicated RRC message to the new variable parameter value received on the MCCH based on the reference identifier.

In a second aspect, a communication method is used in a mobile communication system that provides a multicast/broadcast service (MBS), the communication method including the steps of: receiving, by a user equipment in a radio resource control (RRC) connected state and having joined a multicast session, configuration information for configuring whether the user equipment monitors a multicast control channel (MCCH) in an RRC inactive state from a network node; and monitoring, by the user equipment having transitioned from the RRC connected state to the RRC inactive state, the MCCH based on the configuration information.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIGS. 6A and 6B are diagrams illustrating an operation of the UE in an RRC inactive state to perform multicast reception.

FIG. 7 is a flowchart illustrating an operation example of the mobile communication system according to an embodiment.

FIG. 8 is a flowchart illustrating an operation example of the mobile communication system according to a modification.

### DESCRIPTION OF EMBODIMENTS

A mobile communication system according to an embodiment is described with reference to the drawings. In the description of the drawings, the same or similar parts are denoted by the same or similar reference signs.

### System Configuration

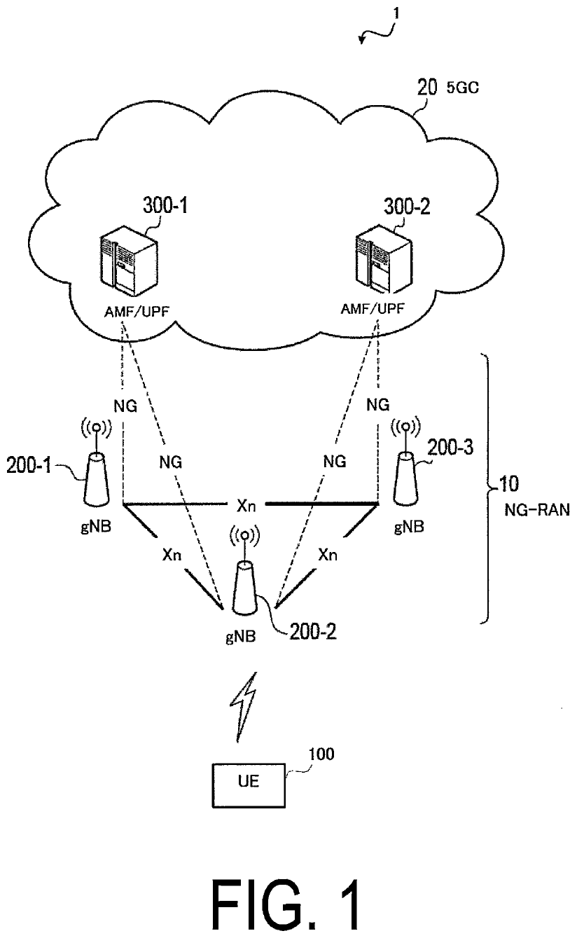

FIG. 1 is a diagram illustrating a configuration of a mobile communication system according to an embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10 (a network 10). The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (vehicle UE), and a flying object or an apparatus provided on a flying object (aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

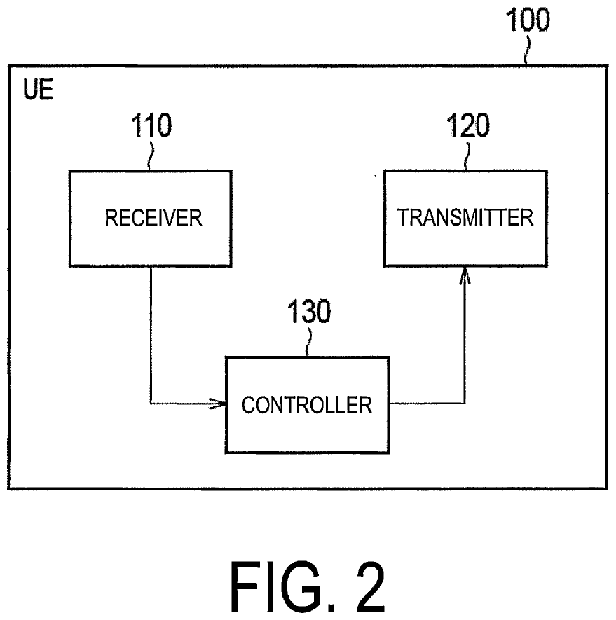

FIG. 2 is a diagram illustrating a configuration of the UE 100 (user equipment) according to an embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The operations of the UE 100 described above and below may also be performed under the control of a controller 230. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

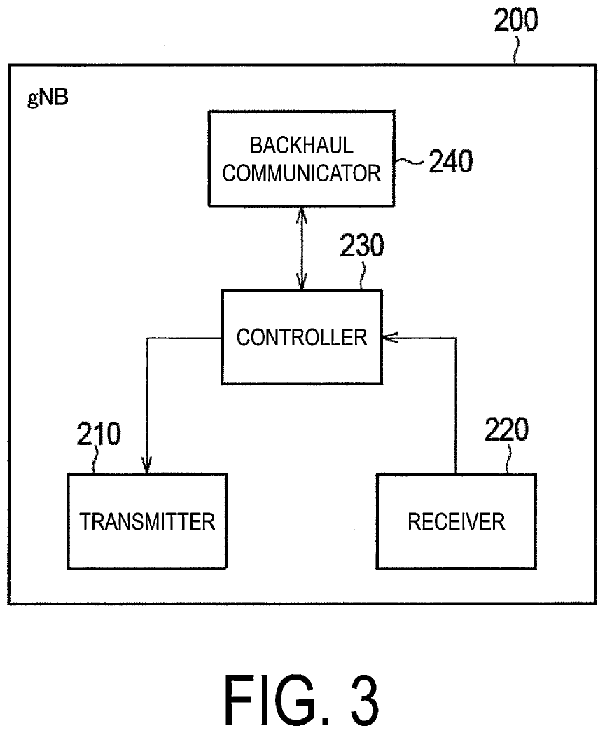

FIG. 3 is a diagram illustrating a configuration of the gNB 200 (base station) according to an embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The operations of the gNB 200 described above and below may also be performed under the control of the controller 230. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via an NG interface between a base station and the core network. Note that the gNB 200 may include a Central Unit (CU) and a Distributed Unit (DU) (i.e., functions are divided), and both units may be connected via an F1 interface that is a fronthaul interface.

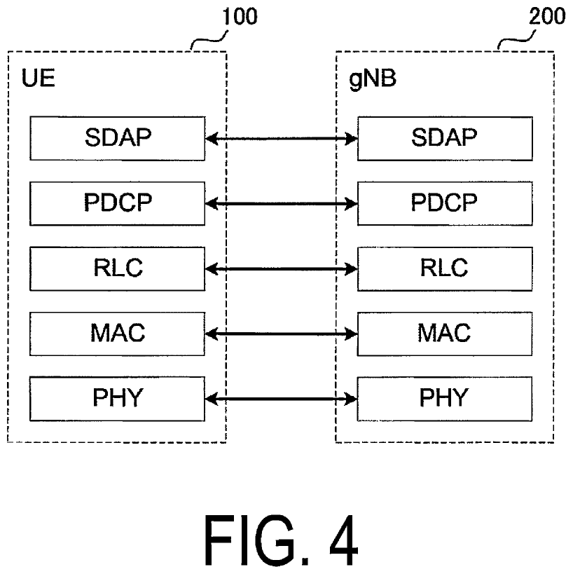

FIG. 4 is a diagram illustrating a configuration of a protocol stack of a radio interface of a user plane handling data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

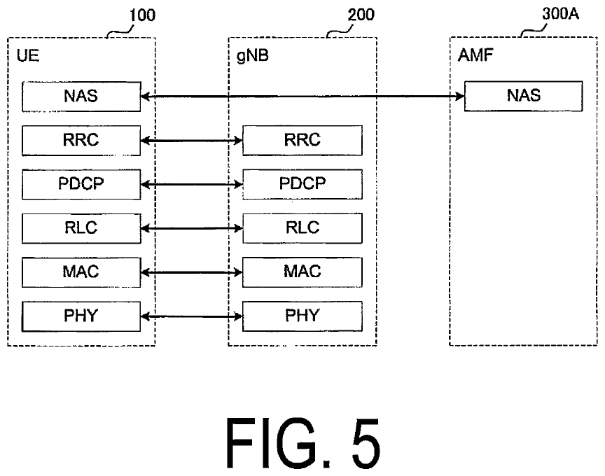

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection is present between the RRC of the UE 100 and the RRC of the gNB 200 (RRC connection), the UE 100 is in an RRC connected state. When no connection is present between the RRC of the UE 100 and the RRC of the gNB 200 (RRC connection), the UE 100 is in an RRC idle state. When the connection between the RRC of the UE 100 and the RRC of the gNB 200 is suspended, the UE 100 is in an RRC inactive state.

The NAS layer that is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. A layer lower than the NAS layer is referred to as an AS layer.

### Overview of MBS

The mobile communication system 1 can perform delivery with high resource efficiency by using the multicast/broadcast service (MBS).

In a multicast communication service (also referred to as “MBS multicast”), the same service and the same specific content data are simultaneously provided to a specific UE set. That is, not every UE 100 in the multicast service area is allowed to receive data. The multicast communication services are delivered to the UE 100 using a multicast session, which is a type of MBS session. The UE 100 can receive the multicast communication services in the RRC connected state using mechanisms such as Point-to-Point (PTP) and/or Point-to-Multipoint (PTM) delivery. The UE 100 may receive the multicast communication services in the RRC inactive (or RRC idle) state. Such a delivery mode is also referred to as “delivery mode 1”.

In the broadcast communication services (also referred to as “MBS broadcast”), the same service and the same specific content data are provided simultaneously to every UE 100 within a geographic area. That is, every UE 100 in the broadcast service area is allowed to receive the data. The broadcast communication services are delivered to the UE 100 using a broadcast session, which is a type of MBS session. The UE 100 can receive the broadcast communication services in any state of the RRC idle state, the RRC inactive state, and the RRC connected state. Such a delivery mode is also referred to as “delivery mode 2”.

Main logical channels used for MBS delivery are a multicast traffic channel (MTCH), a dedicated traffic channel (DTCH), and a multicast control channel (MCCH). The MTCH is a PTM downlink channel for transmitting MBS data of either a multicast session or a broadcast session from the network 10 to the UE 100. The DTCH is a PTP channel for transmitting MBS data of a multicast session from the network 10 to the UE 100. The MCCH is a PTM downlink channel for transmitting MBS broadcast control information associated with one or more MTCHs from the network 10 to the UE 100.

Regarding a configuration in MBS broadcast, the UE 100 in the RRC idle state, the RRC inactive state, or the RRC connected state receives an MBS configuration for a broadcast session (e.g., parameters required for MTCH reception) via the MCCH. Parameters required for reception of the MCCH (MCCH configuration) are provided through system information. In particular, system information block type 20 (SIB 20) includes the MCCH configuration. Note that SIB type 21 (SIB 21) includes information related to service continuity of MBS broadcast reception. The MCCH provides a list of all broadcast services including ongoing sessions transmitted on the MTCH, and the information related to the broadcast session includes an MBS session ID (e.g., Temporary Mobile Group Identity (TMGI)), related MTCH scheduling information, and information about a neighboring cell providing a specific service on the MTCH.

On the other hand, with respect to MBS multicast, the current technical specifications of the 3GPP enable the UE 100 to receive data of multicast sessions only in RRC connected state. When the UE 100 joining a multicast session is in the RRC connected state and the multicast session is activated, the gNB 200 transmits an RRC reconfiguration message including an MBS configuration related to the multicast session to the UE 100. Such an MBS configuration is also referred to as a multicast radio bearer (MRB) configuration, an MTCH configuration, or a multicast configuration. Such an MRB configuration (MRB-ToAddMod) includes an MBS session ID (mbs-SessionId), an MRB ID (mrb-Identity), and other parameters such as a PDCP configuration (pdcp-Config) for an MRB (multicast MRB) to be configured for the UE 100.

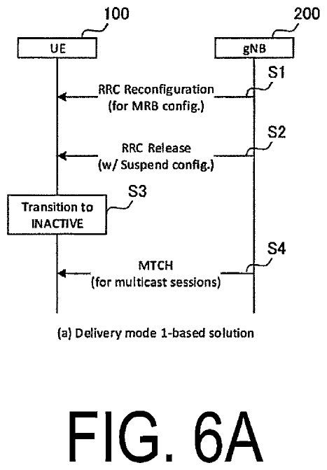

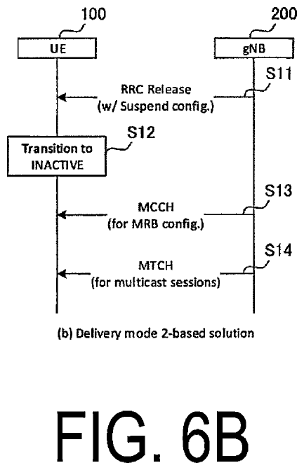

In the following embodiment, an operation of enabling the UE 100 in the RRC inactive state to perform multicast reception will be mainly described. FIGS. 6A and 6B illustrate an overview of the operation.

As a solution for the UE 100 in the RRC inactive state to perform multicast reception, a solution based on the delivery mode 1 illustrated in FIG. 6A and a solution based on the delivery mode 2 illustrated in FIG. 6B are considered.

In the solution based on the delivery mode 1 illustrated in FIG. 6A, in step S1, the gNB 200 transmits an RRC Reconfiguration message including the MBS configuration (multicast configuration) related to multicast sessions to the UE 100 in the RRC connected state. The UE 100 receives the multicast data on the MTCH via the multicast sessions (multicast MRB) based on the multicast configuration received in the RRC Reconfiguration message.

In step S2, the gNB 200 transmits an RRC release (Release) message for causing the UE 100 to transition to the RRC inactive state to the UE 100 in the RRC connected state. The RRC Release message includes a configuration (Suspend Config.) for the RRC inactive state.

In step S3, the UE 100 transitions from the RRC connected state to the RRC inactive (INACTIVE) state in response to receiving the RRC Release message in step S2.

In step S4, the UE 100 in the RRC inactive state continues using the multicast configuration of step S1 to receive the multicast data on the MTCH through the multicast sessions.

This enables the UE 100 in the RRC inactive state to perform multicast reception. Note that, although an example in which multicast configuration is performed using an RRC Reconfiguration message has been described, multicast configuration may be performed using an RRC Release message.

Both the RRC Reconfiguration message and the RRC Release message are RRC messages transmitted per UE on the dedicated control channel (DCCH), and are hereinafter also referred to as dedicated RRC messages.

On the other hand, in the solution based on the delivery mode 2 illustrated in FIG. 6B, in step S11, the gNB 200 transmits an RRC Release message for causing the UE 100 to transition to the RRC inactive state to the UE 100 in the RRC connected state. The RRC Release message includes a configuration (Suspend Config.) for the RRC inactive state.

In step S12, the UE 100 transitions to the RRC inactive (INACTIVE) state in response to receiving the RRC Release message in step S11.

In step S13, the gNB 200 transmits the MCCH including the MBS configuration (multicast configuration) for the multicast sessions. The UE 100 receives the MCCH. Note that the UE 100 receives the SIB 20 prior to the reception of the MCCH, and receives the MCCH based on the SIB 20. The MCCH transmission (and reception) may be performed before step S11 or simultaneously with step S11.

In step S14, the UE 100 in the RRC inactive state receives the multicast data on the MTCH via the multicast sessions based on the multicast configuration received on the MCCH in step S13. This enables the UE 100 in the RRC inactive state to perform multicast reception.

### System Operation Example

In an embodiment, delivery mode 1 and delivery mode 2-based solutions are combined to enable the UE 100 in the RRC inactive state to efficiently perform multicast reception.

To be more specific, first, when the UE 100 is in an RRC connected state, the UE 100 receives a multicast configuration (first multicast configuration) in a dedicated RRC message.

Second, the UE 100 transitions from the RRC connected state to the RRC inactive state. The UE 100 in the RRC inactive state may perform multicast reception using the first multicast configuration until a second multicast configuration is received. Third, the UE 100 receives a multicast configuration (second multicast configuration) on the MCCH when the UE 100 is in the RRC inactive state.

As described above, only a specific UE group (specific UE set) can receive the MBS multicast. The multicast configuration includes at least one of parameter values such as an identifier of a multicast session (multicast service) received by a specific UE group, for example, Temporary Mobile Group Identity (TMGI) and Group Radio Network Temporary Identifier (G-RNTI).

Such parameter values are UE group specific-parameters, and security (and privacy protection) for the parameter values may be required. However, since the MCCH is a logical channel that all UEs can receive, transmitting a parameter value that may require security on the MCCH is not preferable.

In the embodiment, a parameter value for which security is required is configured in a dedicated RRC message, and the MCCH transmits a parameter value other than the parameter value. That is, the parameter values for which security is required are not transmitted on the MCCH, and the parameter values transmitted in the dedicated RRC message are continuously used. In the following, a continuously used parameter value is also referred to as a fixed parameter value. Meanwhile, a parameter value that is transmitted in the dedicated RRC message and on the MCCH and can be updated is referred to as a variable parameter value.

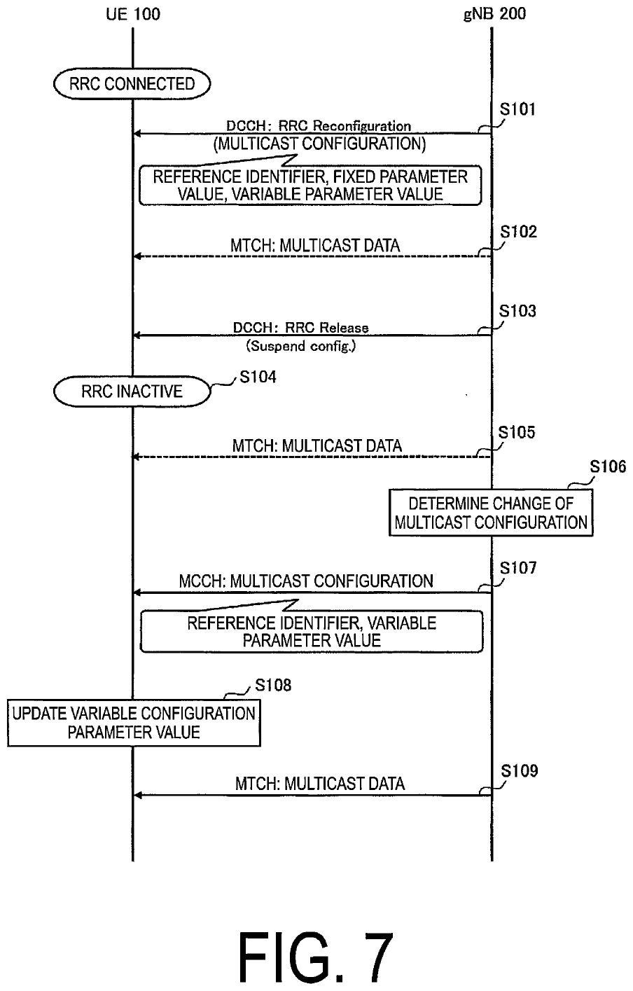

FIG. 7 is a flowchart illustrating an operation example of the mobile communication system 1 according to an embodiment. Prior to the present operation, it is assumed that the UE 100 has joined a multicast session. It is also assumed that the UE 100 is performing or will perform multicast reception in the RRC connected state.

In step S101, the gNB 200 transmits the first multicast configuration including a reference identifier, the fixed parameter value that is not updated by the MCCH, and the variable parameter value that can be updated by the MCCH to the UE 100 in the RRC connected state by using a dedicated RRC message. That is, the gNB 200 configures the first multicast configuration for each UE. The UE 100 may receive the dedicated RRC message including the first multicast configuration from the gNB 200 and stores the first multicast configuration. Part of the first multicast configuration may be updated by the MCCH. For this reason, the first multicast configuration can be regarded as a base multicast configuration. Note that some or all of the variable parameter values that can be updated by the MCCH may not be included in the first multicast configuration. In this case, the multicast configuration is not completed until the second multicast configuration to be described below is received. In other words, the UE 100 can receive the multicast (MTCH) by receiving the first multicast configuration and the second multicast configuration.

In the illustrated example, the dedicated RRC message including the first multicast configuration is an RRC Reconfiguration message. However, the dedicated RRC message may be an RRC Release message. The fixed parameter value and the variable parameter values may be configured in an RRC Reconfiguration message, and the reference identifier may be configured in an RRC Release message.

The reference identifier is an identifier capable of specifying the multicast configuration and is an identifier other than the TMGI and G-RNTI. The reference identifier may be an MRB identifier (MRB ID). However, since the MRB ID is unique to the UE, a new identifier unique to the multicast group may be used as the reference identifier.

The fixed parameter value includes the TMGI and/or G-RNTI associated with the multicast session.

The variable parameter values include at least one of a transmission cycle or a transmission duration of the MTCH associated with the multicast session. The variable parameter values may include a PDSCH configuration of the MTCH. The variable parameter values may include at least one selected from the group consisting of drx-ConfigPTM-List, pdsch-ConfigMTCH, mtch-SSB-MappingWindowList, mtch-SchedulingInfo, pdsch-ConfigIndex, mtch-SSB-MappingWindowIndex, and drx-ConfigPTM defined in the 3GPP Technical Specifications.

Here, which parameter (to be specific, which information element in the first multicast configuration) is to be a fixed parameter or a variable parameter may be defined in advance in technical specifications or may be determined based on the configuration of the gNB 200. In the latter case, for example, in step S101, the gNB 200 may transmit information specifying at least one of the parameter type of the fixed parameter or the parameter type of the variable parameter to the UE 100. Based on the information, the UE 100 specifies whether each parameter included in the first multicast configuration configured in the dedicated RRC message is a fixed parameter or a variable parameter.

In step S102, the gNB 200 may transmit the multicast data on the MTCH via the multicast session based on the first multicast configuration of step S101. The UE 100 may receive the multicast data on the MTCH via the multicast session based on the first multicast configuration of the S101.

In step S103, the gNB 200 determines to cause the UE 100 to transition from the RRC connected state to the RRC inactive state and transmits an RRC Release message including Suspend config. to the UE 100. The UE 100 receives the RRC Release message. Note that the above-described first multicast configuration may be included in the RRC Release message. In this case, step S101 may not be necessary.

In step S104, the UE 100 transitions to the RRC inactive state from the RRC connected state upon reception of the RRC Release message in step S103.

In step S105, the gNB 200 may transmit the multicast data on the MTCH via the multicast session based on the first multicast configuration of step S101. The UE 100 having transitioned to the RRC inactive state may receive the multicast data on the MTCH via the multicast session based on the first multicast configuration of the S101.

In step S106, the gNB 200 determines to update the multicast configuration (first multicast configuration) configured in step S101. For example, the gNB 200 may determine to change the transmission cycle of the MTCH associated with the multicast session. The gNB 200 may determine to change the transmission duration of the MTCH. The transmission duration refers to the duration in which one MTCH transmission operation lasts based on the transmission cycle.

In step S107, the gNB 200 transmits the second multicast configuration including the reference identifier and the new variable parameter value to the UE 100 on the MCCH. The UE 100 in the RRC inactive state receives the second multicast configuration.

The reference identifier in the second multicast configuration is an identifier for specifying the above-described first multicast configuration, and is an MRB identifier or a newly defined identifier. The new variable parameter value in the second multicast configuration is a parameter value after updating the variable parameter value of the first multicast configuration. However, parameter values that are not updated among the variable parameter values may not be included in the second multicast configuration.

The second multicast configuration does not include a fixed parameter value, for example, a TMGI and/or a G-RNTI. Thus, the occurrence of security problems can be avoided. For example, the fact that a UE 100 not joining the multicast session tries to receive the multicast session can be easily avoided. Since the TMGI has a large number of bits, the TMGI is not transmitted on the MCCH, thereby contributing to reduction of the overhead of the MCCH.

In step S108, the UE 100 in the RRC inactive state updates the variable parameter value received in the dedicated RRC message (first multicast configuration) to the new variable parameter value received on the MCCH (second multicast configuration) based on the reference identifier (i.e., using the reference identifier as a key). That is, the UE 100 overwrites the stored variable parameter value with the new variable parameter value while maintaining the stored fixed parameter value. In this way, when the second multicast configuration (MCCH) includes a reference identifier that matches the reference identifier in the currently stored multicast configuration, the UE 100 in the RRC inactive state applies the parameters updated on the MCCH to the base multicast configuration.

In step S109, the gNB 200 may transmit the multicast data on the MTCH via the multicast session based on the second multicast configuration of step S107. The UE 100 in the RRC inactive state receives the multicast data on the MTCH via the multicast session from the gNB 200 based on the second multicast configuration of step S107, specifically, the multicast configuration after the update of step S108 (the fixed parameter value and the new variable parameter value).

### Modification of Operation

A modification of the operation according to the above-described embodiment will be described. In the above-described embodiment, it is assumed that the UE 100 in the RRC inactive state monitors the MCCH after the multicast configuration is performed in the dedicated RRC message.

However, in a case in which the multicast configuration configured by the dedicated RRC message is not updated after the configuration, power of the UE 100 may be wastefully consumed when the UE 100 monitors the MCCH. For this reason, in the present modification, the gNB 200 can configure whether the UE 100 needs to monitor the MCCH to the UE 100. To be specific, the gNB 200 configures, to the UE 100, whether the UE 100 needs to monitor the MCCH during multicast reception in the RRC inactive state.

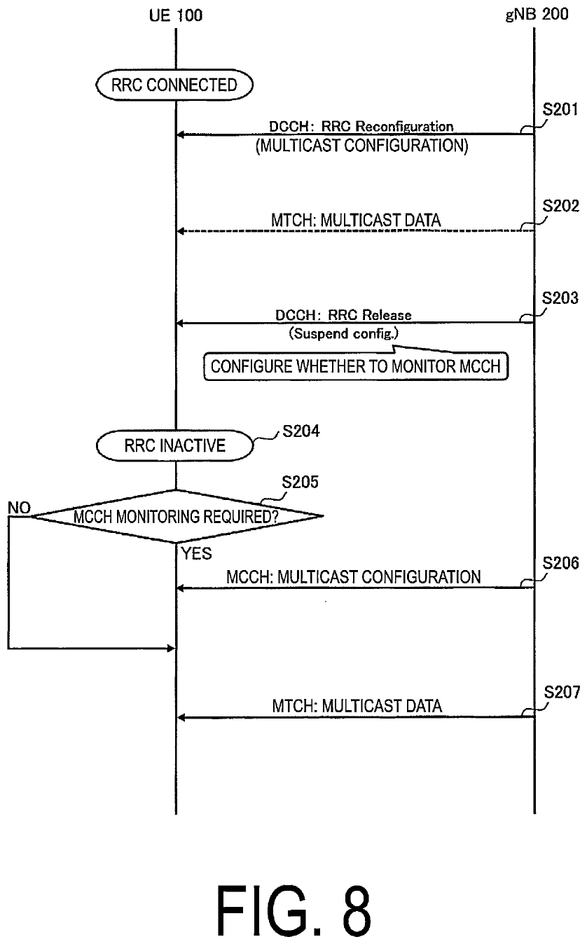

FIG. 8 is a flowchart illustrating an operation example of the mobile communication system 1 according to the present modification. Prior to the present operation, it is assumed that the UE 100 has joined a multicast session. It is also assumed that the UE 100 is performing or will perform multicast reception in the RRC connected state. Description will not be repeated with respect to operations same as or similar to that described above.

In step S201, the gNB 200 may transmit a multicast configuration to the UE 100 in the RRC connected state using a dedicated RRC message (in the illustrated example, an RRC Reconfiguration message; however, the message may be an RRC Release message (step S203)). The UE 100 receives the multicast configuration in the dedicated RRC message.

In step S202, the gNB 200 may transmit multicast data on the MTCH via the multicast session based on the multicast configuration of step S201. The UE 100 may receive the multicast data on the MTCH via the multicast session based on the multicast configuration of step S201.

In step S203, the gNB 200 determines to cause the UE 100 to transition from the RRC connected state to the RRC inactive state and transmits an RRC Release message including Suspend config. to the UE 100. The UE 100 receives the RRC Release message.

In the illustrated example, the gNB 200 includes, in the RRC Release message, configuration information for configuring whether the UE 100 monitors the MCCH in the RRC inactive state. That is, the RRC Release message includes configuration information for designating whether to perform a reception operation of the MCCH when the UE 100 performs (or waits for) multicast reception in the RRC inactive state. Instead of including the configuration information in the RRC Release message (step S203), the RRC Reconfiguration message (step S201) may include the configuration information. Hereinafter, an example in which the RRC Release message (step S203) includes the configuration information will be described. When the gNB 200 configures the UE 100 to monitor the MCCH, the gNB 200 may include the MCCH configuration to be transmitted in the SIB20 in a dedicated RRC message (RRC Release message or RRC Reconfiguration message) and transmit the dedicated RRC message to the UE 100.

In step S204, the UE 100 transitions to the RRC inactive state from the RRC connected state upon reception of the RRC Release message in step S203.

In step S205, the UE 100 in the RRC inactive state checks whether the UE 100 is configured in step S203 to monitor the MCCH.

When the UE 100 is configured to monitor the MCCH (step S205: YES), in step S206, the UE 100 in the RRC inactive state monitors the MCCH and receives the MCCH (multicast configuration). Note that the UE 100 receives the SIB20 prior to the reception of the MCCH, and monitors and receives the MCCH based on the SIB20. The UE 100 receives the multicast data on the MTCH via the multicast session based on the received MCCH (step S207). The UE 100 may perform the MCCH reception after the MTCH reception. That is, the MCCH reception (step S206) and the MTCH reception (step S207) may be performed in parallel.

On the other hand, when the UE 100 is configured not to monitor the MCCH (step S205: NO), in step S207, the UE 100 in the RRC inactive state continues using the multicast configuration of step S201 without monitoring the MCCH to receive the multicast data on the MTCH via the multicast session.

Note that the present modification may be on the premise of the operation according to the above-described embodiment. That is, each of the multicast configuration of step S201 (first multicast configuration) and the multicast configuration of step S205 (second multicast configuration) may include a reference identifier, and the second multicast configuration may update the variable parameter value of the first multicast configuration.

### Other Embodiment

Although multicast reception in the RRC inactive state has been mainly described in the above-described embodiments, the operations according to the above-described embodiments may be applied to multicast reception in the RRC idle state. That is, the “RRC inactive state” in the operations according to the above-described embodiments and their modification may be read as “RRC idle state”. With respect to the RRC idle state, RRC recovery (Resume) can be read as RRC establishment (Establishment).

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a mobile termination (MT) of the IAB node.

Although the term “network node” mainly refers to a base station, it may also refer to an apparatus of a core network or a part (CU, DU or RU) of a base station.

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### SUPPLEMENTARY NOTE

Features relating to the embodiments described above are described below as supplements.

### Supplementary Note 1

A communication method used in a mobile communication system that provides a multicast/broadcast service (MBS), the communication method including the steps of:
receiving, by a user equipment in a radio resource control (RRC) connected state, a first multicast configuration from a network node in a dedicated RRC message, the first multicast configuration including a reference identifier, a fixed parameter value, and a variable parameter value;
receiving, by the user equipment having transitioned from the RRC connected state to an RRC inactive state, a second multicast configuration from the network node on a multicast control channel (MCCH), the second multicast configuration including the reference identifier and a new variable parameter value; and
updating, by the user equipment in the RRC inactive state, the variable parameter value received in the dedicated RRC message to the new variable parameter value received on the MCCH, based on the reference identifier.

### Supplementary Note 2

The communication method described in supplementary note 1, further including:
receiving, by the user equipment in the RRC inactive state, multicast data from the network node via a multicast session, based on the fixed parameter value and the new variable parameter value.

### Supplementary Note 3

The communication method described in supplementary note 1 or 2, further including:
receiving, from the network node, information specifying at least one of a parameter type of a fixed parameter that is not updated by the MCCH or a parameter type of a variable parameter that is updatable by the MCCH.

### Supplementary Note 4

The communication method described in any one of supplementary notes 1 to 3, in which the fixed parameter value includes at least one of Temporary Mobile Group Identity (TMGI) or Group Radio Network Temporary Identifier (G-RNTI).

### Supplementary Note 5

The communication method described in any one of supplementary notes 1 to 4, in which the variable parameter value includes at least one of a transmission cycle or a transmission duration of a multicast traffic channel (MTCH).

### Supplementary Note 6

A communication method used in a mobile communication system that provides a multicast/broadcast service (MBS), the communication method including the steps of:
receiving, by a user equipment in a radio resource control (RRC) connected state and having joined a multicast session, configuration information for configuring whether the user equipment monitors a multicast control channel (MCCH) in an RRC inactive state from a network node; and
monitoring, by the user equipment having transitioned from the RRC connected state to the RRC inactive state, the MCCH based on the configuration information.

### Supplementary Note 7

The communication method described in supplementary note 6, further including: transitioning, of the user equipment in the RRC connected state, from the RRC connected state to the RRC inactive state in response to reception of an RRC release message from the network node,
in which the configuration information is information included in the RRC release message.

### Supplementary Note 8

The communication method described in supplementary note 6, further including:
receiving, by the user equipment in the RRC connected state, an RRC reconfiguration message from the network node, the RRC reconfiguration message including a multicast configuration required for reception of the multicast session,
in which the configuration information is information included in the RRC reconfiguration message.

### REFERENCE SIGNS

1: Mobile communication system
10: RAN
20: CN
100: User equipment (UE)
110: Receiver
120: Transmitter
130: Controller
200: gNB (Base station)
210: Transmitter
220: Receiver
230: Controller
240: Backhaul communicator

1. A communication method used in a mobile communication system configured to provide a multicast/broadcast service (MBS), the communication method comprising the steps of:
receiving, by a user equipment in a radio resource control (RRC) connected state and having joined a multicast session, an RRC Release message for indicating whether the user equipment is configured to receive the multicast session in an RRC inactive state from a network node;
transitioning, by the user equipment from the RRC connected state to the RRC inactive state, upon reception of the RRC Release message;
receiving, by the user equipment having transitioned to the RRC inactive state, a multicast control channel (MCCH) from the network node, if the received RRC Release message does not include specified information; and
receiving, by the user equipment having transitioned to the RRC inactive state, a multicast traffic channel (MTCH) from the network node, if the received RRC Release message includes the specified information.

2. The communication method according to claim 1, further comprising:
receiving, by the user equipment having transitioned to the RRC inactive state, the MTCH from the network node without receiving the MCCH, if the received RRC Release message includes the specified information.

3. A user equipment in a mobile communication system configured to provide a multicast/broadcast service (MBS), the user equipment comprising:
a receiver circuitry, receiving, an RRC Release message for indicating whether the user equipment in a radio resource control (RRC) connected state and having joined a multicast session is configured to receive the multicast session in an RRC inactive state from a network node;
a controller circuitry, transitioning, the user equipment from the RRC connected state to the RRC inactive state, upon reception of the RRC Release message; wherein
the receiver circuitry, receiving, a multicast control channel (MCCH) from the network node after the user equipment transitioned to the RRC inactive state, if the received RRC Release message does not include specified information; and
the receiver circuitry, receiving, a multicast traffic channel (MTCH) from the network node after the user equipment transitioned to the RRC inactive state, if the received RRC Release message includes the specified information.

4. A chipset for a user equipment in a mobile communication system configured to provide a multicast/broadcast service (MBS), the chipset comprising:
a circuity configured to:
receive, an RRC Release message for indicating whether the user equipment in a radio resource control (RRC) connected state and having joined a multicast session is configured to receive the multicast session in an RRC inactive state from a network node;
transition, the user equipment from the RRC connected state to the RRC inactive state, upon reception of the RRC Release message;
receive, a multicast control channel (MCCH) from the network node after the user equipment transitioned to the RRC inactive state, if the received RRC Release message does not include specified information; and
receive, a multicast traffic channel (MTCH) from the network node after the user equipment transitioned to the RRC inactive state, if the received RRC Release message includes the specified information.
